(19) United States
(12) Patent Application Publication
(10) Pub. No.: US 2009/0296556 A1
(43) Pub. Date: Dec. 3, 2009

(54) READING DEVICE FOR A RECORD CARRIER

(75) Inventors: Alexander Marc Van Der Lee, Eindhoven (NL); Willem Marie Julia Marcel Coene, Eindhoven (NL); Andries Pieter Hekstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,495

(22) PCT Filed: Dec. 15, 2005
(86) PCT No.: PCT/IB2005/054258

§ 371 Date: Jun. 12, 2007

(30) Foreign Application Priority Data
Dec. 20, 2004 (EP) 04106727.3

(51) Int. Cl. G11B 7/00

(52) U.S. Cl. 369/100; G9B/7

(57) ABSTRACT

The invention provides an efficient reading device in which, even if one radiation beam should fail, no information is lost and the information can still be read out without time-consuming recurring operations. The present invention solves this problem by providing a reading device (FIG. 5A) and a means (FIG. 4) for forming read-out spots (A, B, C, D, E) that are built up by multiple radiation beams from the radiation source (4). This has the advantage that each read-out spot will have energy contributions from different radiation beams and, should one radiation beam break down, the intensity of some of the read-out spots may indeed diminish, but the information can still be read out thanks to the contributions from other radiation beams.

The present invention relates to a reading device for retrieving information from a record carrier, comprising illuminating means for simultaneously illuminating tracks of the record carrier by at least two separate radiation beams, the information recorded in the illuminated tracks being retrieved from reflected portions of the radiation beams.

U.S. Pat. No. 6,373,793 discloses a reading device for retrieving information from an optical disc. The reading device comprises illuminating means for simultaneously illuminating tracks of the optical disc by at least two separate radiation beams, the information recorded in the illuminated tracks being retrieved from reflected portions of the radiation beams.

In the reading device disclosed in U.S. Pat. No. 6,373,793, it has been recognized that if one of the radiation beams fails, the read-out is obtained from the remaining radiation beam, so that no information is lost. This read-out is performed in recurring operations. The information is read for one revolution of the optical disc and a forward track jump of two tracks is carried out. At this point, the recorded information is again read for one more revolution and the process repeats. Such a reading requires a track jump and recurring operations to be performed for additional revolutions of the optical disc in order still to be able to read all the information without any substantial loss, which is time-consuming. Thus the reading speed is lower.

It is an object of the present invention to provide an efficient reading device for retrieving information from a record carrier in which, even if one radiation beam should fail, the information is still read out without a reduction in reading speed.

The object of the invention is achieved by providing a reading device as mentioned in the opening paragraph, which is characterized in that the illuminating means are adapted for illuminating at least one read-out spot consisting of contributions from at least two of the at least two radiation beams on a plurality of tracks. This has the advantage that each read-out spot has energy contributions from different radiation beams. If one radiation beam breaks down, the information can still be read out with the contributions from other radiation beams. This does not require recurring operations for additional revolutions of the optical disc and does not require a track jump as needed in the prior art reading device disclosed in U.S. Pat. No. 6,373,793. Thus reading speed can be substantially maintained. In an embodiment of the invention, the illuminating means comprise a holographic element for transforming at least two radiation beams each into at least two sub-radiation beams, wherein the illuminating means are adapted for forming at least one read-out spot by combining sub-radiation beams from at least two of the at least two separate radiation beams. The holographic element transforms each radiation beam into an array of sub-radiation beams. These sub-radiation beams are used in the construction of read-out spots. The read-out spots are constructed such that each readout spot has contributions from different radiation beams. Hence, if one radiation beam breaks down, the information can still be read out with the contributions from other radiation beams. The read-out spots thus constructed by means of the holographic element are preferably illuminated on N tracks of the optical disc.

In a preferred embodiment, the holographic element used is a grating element. It is noted that such a grating element is known per se from U.S. Pat. No. 6,373,793. However, in U.S. Pat. No. 6,373,793, the grating element is only used for diffraction of radiation beams, not for transforming a radiation beam into an array of sub-radiation beams and the construction of read-out spots in accordance with the present invention.

The grating element preferably is a periodic structure with a unit cell that is repeated. The grating element is made by embossing a periodic surface variation into a material. Due to the differences in surface height, the phase of the radiation beam is spatially modulated. In a reading device according to the invention, a binary phase grating is preferably used in which a height difference essentially corresponds to the phase difference. In order to switch the grating, the height is effectively switched on/off. The switching is applied to change the reading device from a write mode to a read mode and vice versa. The radiation beams are unchanged in the write mode, whereas in the read mode sub beams of different radiation beams overlap so as to form read-out spots.

Preferably, the grating is made of a birefringent material, so that the grating has a different refractive indices for different linear polarization directions of the radiation beam. According to a further embodiment, the grating is formed by a liquid crystalline (LC) cell. The application of a voltage change modifies the refractive index of the LC material for one linear polarization direction of the radiation beam. The grating structure is placed within an LC material. The heights of the structure and of the LC material are matched such that the phase depth is a multiple of 2 pi for one voltage value, and for the other voltage value it is the desired phase depth.

In a further embodiment, the grating element comprises two grating elements in different positions. One of these elements may be a simple glass plate without significant spatial height variations. The grating elements can be moved with respect to the radiation beams.

In a further embodiment, the illuminating means for simultaneously illuminating tracks of the record carrier are formed by different radiation sources. In this case, the failure of one radiation source is preferably compensated for by an increase in the power supplied to the remaining radiation sources.

Furthermore, a reading device according to an embodiment of the present invention may advantageously be incorporated in a drive system for reading record carriers, such as a CD, DVD, Blu-Ray, TwoDOS, or multi-beam near-field player.

These and other aspects of the invention and advantages will be apparent from the embodiments described in the following description and with reference to the accompanying drawings, in which,

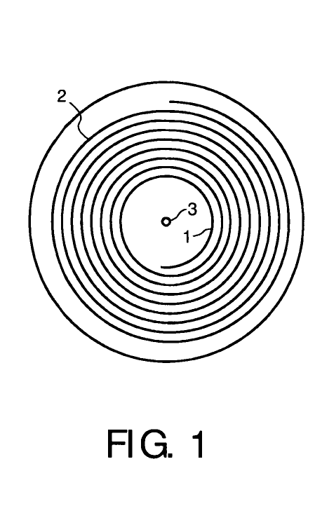

FIG. 1 shows a record carrier;

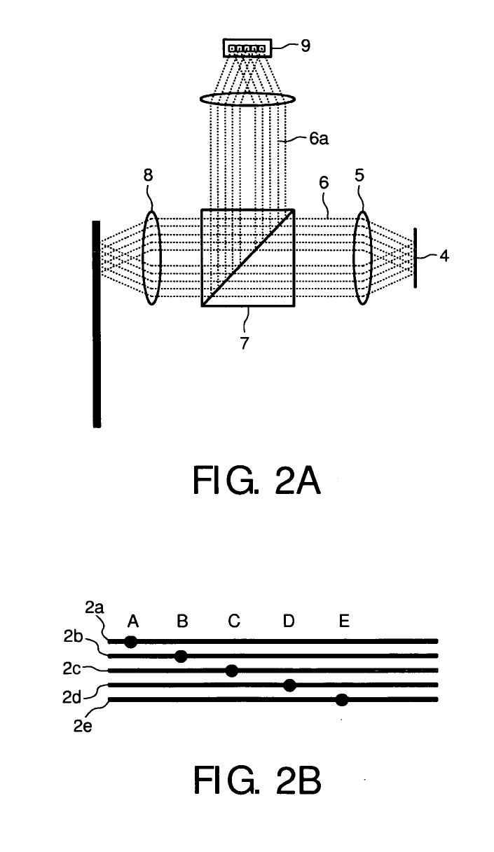

FIG. 2A shows a prior art reading device for reading information from a record carrier;

FIG. 2B shows the read-out spots formed on five tracks using the prior art reading device;

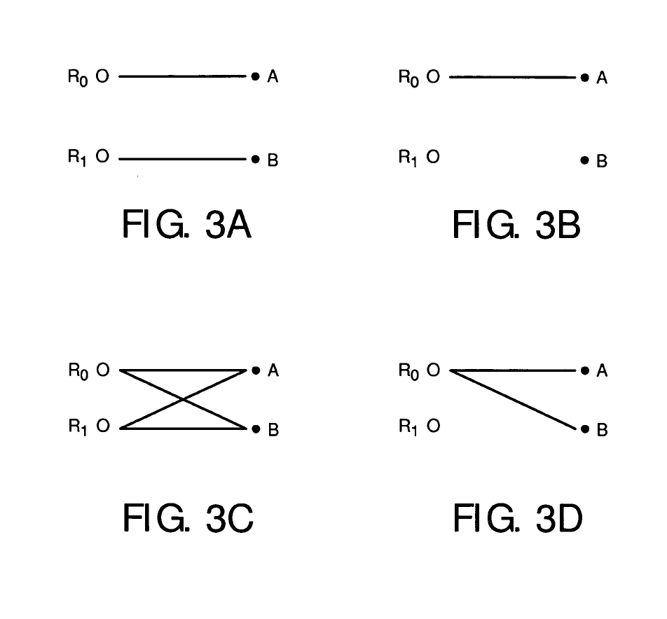

FIG. 3A, FIG. 3B illustrate read-out spots built up by the prior art reading device;

FIG. 3C and FIG. 3D illustrate read-out spots built up by multiple radiation beams in accordance with the present invention;

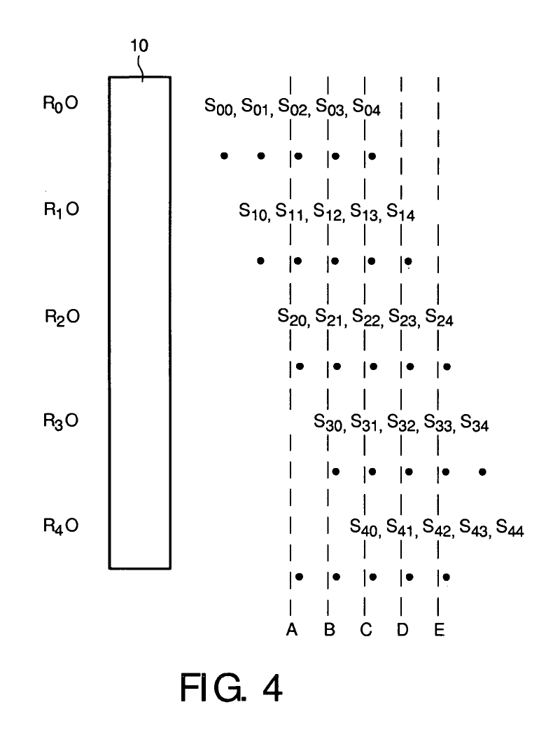

FIG. 4 shows the construction of the read-out spots according to the invention;

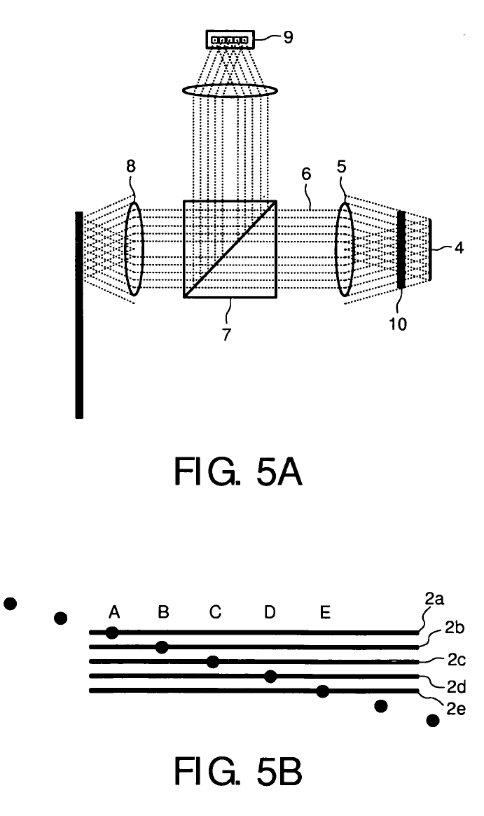

FIG. 5A shows a reading device in accordance with the present the invention;

FIG. 5B shows read-out spots formed on five tracks using the reading device in accordance with the present invention;

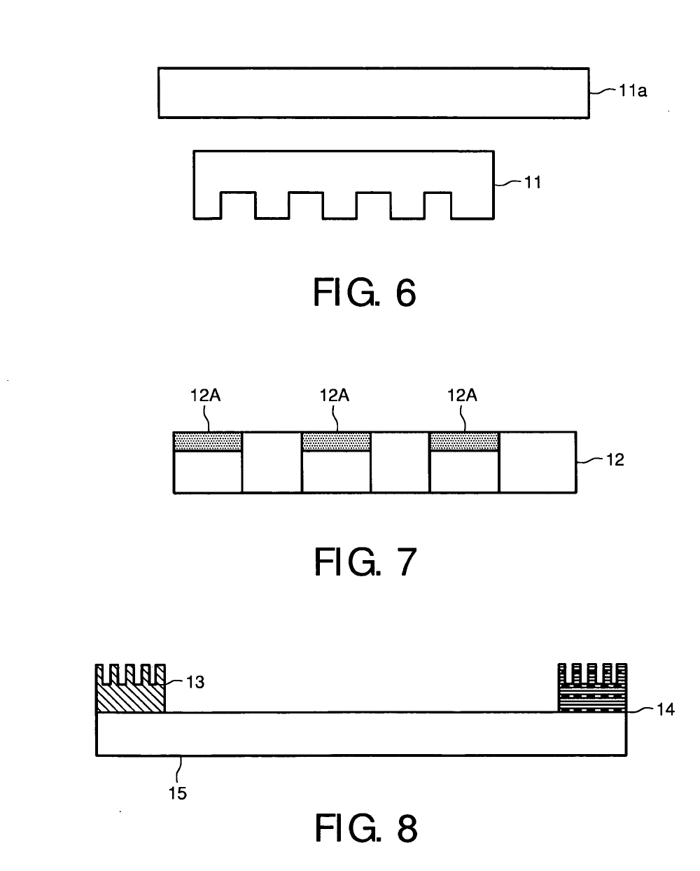

FIG. 6 shows an embodiment of the invention wherein a grating element is made of a birefringent material;

FIG. 7 shows an embodiment of the invention wherein a grating element is formed by a LC material; and

FIG. 8 shows an embodiment of the invention wherein the grating element consists of two grating elements in different positions.

FIG. 1 shows a disc-shaped record carrier 1 having a single track 2 and a center hole 3. The track represents a series of pre-recorded or recordable marks representing information and is arranged in a spiraling pattern. The tracks 2 may alternatively be concentric or parallel. Examples of a recordable disc are CD-R, CD-RW, and writable versions of DVD such as DVD+RW. It should be noted that other types of media, such as a card information carrier on which an information signal is recorded and from which an information signal is reproduced by a radiation beam, may also be used.

FIG. 2A is a prior art reading device for reading an optical disc by the conventional method as disclosed in U.S. Pat. No. 6,373,793. As is shown in FIG. 2A, the reading device consists of radiation source 4 generating radiation beams which are passed through a converging lens 5 to form parallel radiation beams 6. The beam splitter 7 splits the radiation beams. Focusing lens 8 focuses the radiation beams onto the surface of the optical disc 1. Multi-element detectors 9 detect reflected portions 6a of the radiation beams. Having been reflected from the surface of the optical disc 1, the reflected beams 6a pass through the lens 8 and are deflected by the beam splitter 7 so as to become separately incident on the multi-element detectors 9.

FIG. 2B shows the reading of information on five tracks 2a, 2b, 2c, 2d and 2e as disclosed in U.S. Pat. No. 6,373,793. On the optical disc, each read-out spot (A,B,C,D,E) is imaged onto one of the tracks 2a, 2b, 2c, 2d, and 2e. Each read-out spot stems from a single radiation beam and hence, if one radiation beam fails, the corresponding read-out spot is no longer present and a loss of information will result. In the prior art reading device disclosed in U.S. Pat. No. 6,373,793, it has been recognized that, if one of the radiation beam fails, the read-out is performed using the remaining radiation beams so that no information is lost. In the prior art reading device of FIG. 2A, simultaneous reading of five tracks is carried out in recurring operations. The information is read for one revolution of the optical disc, and a forward track jump of two tracks is carried out. At this point the recorded information is again read for one revolution and the process repeats itself. Such a reading requires a track jump and recurring operations to be performed for additional revolutions of the optical disc if it should still be possible to read all the information without any loss, which is a time-consuming process. The problem here is, however, that the reading is interrupted, so the reading speed is reduced. In addition, a similar method is used even for CD, DVD, and other record carriers where plural tracks are reproduced simultaneously and therefore similar problem occurs.

The essence of the invention is illustrated in FIGS. 3A through 3D. FIGS. 3A and 3B illustrate the effect of read-out spots built up by the prior art reading device. In FIG. 3A, two radiation beams Ro and RI form two read-out spots A and B. Read-out spot A is formed from radiation beam Ro and read-out spot B is formed from radiation beam RI. If radiation beam RI fails, the corresponding read-out spot B will not be formed, resulting in a loss of information as shown in FIG. 3B.

According to the invention, the read-out spot is built up from multiple radiation beams, so that each read-out spot has energy contributions from different radiation beams, cf. FIG. 3C. In FIG. 3C, there are two radiation beams Ro and RI and two read-out spots A and B. Read-out spot A is formed from contributions from radiation beam Ro and radiation beam R₁, and read-out spot B is also formed from contributions from radiation beam R₁ and radiation beam Ro. In such a case, if radiation beam R₁ fails, the read-out spot B will still contain contributions from radiation beam Ro. Even though the radiation beam R₁ has failed, the read-out spot B can still be read without any loss of information. Basically, the read-out spots receive energy contributions from different radiation beams. Preferably, the failure of one radiation beam is compensated for by an increase in the power supplied to the remaining radiation beams, the read-out spot being built up from multiple radiation beams, so that no information is lost.

FIG. 4 is a detailed diagram showing how read-out spots in accordance with the invention are formed, assuming that five tracks are read out simultaneously. The construction of the read-out spots is explained in detail below.

A grating element 10 divides each radiation beam (R₀, R₁, R₂, R₃, R₄) into five sub-radiation beams. This results in an array of sub-radiation beams S, m and n being integers in the range from 0 to 4. These sub-radiation beams are used in the construction of read-out spots A, B, C, D, and E as shown in FIG. 4. The contribution to each of the read-out spots can be seen from the vertical broken lines in FIG. 4. In this example:

read-out spot A has contributions from sub-radiation beam S₀₂, sub-radiation beam S₁₁, and sub-radiation beam S₂₀,

read-out spot B has contributions from sub-radiation beam S₀₃, sub-radiation beam S₁₂, sub-radiation beam S₂₁, and sub-radiation beam S₃₀,

read-out spot C has contributions from sub-radiation beam S₀₄, sub-radiation beam S₁₃, sub-radiation beam S₂₂, sub radiation beam S₃₁, and sub-radiation beam S₄₀,

read-out spot D has contributions from sub-radiation beam S₁₄, sub-radiation beam S₂₃, sub-radiation beam S₃₂, and sub-radiation beam S₄₁, and

read-out spot E has contributions from sub-radiation beam S₂₄, sub-radiation beam S₃₃, and sub-radiation beam S42.

The read-out spots A, B, C, D, and E are constructed such that each of the read-out spots will have energy contributions from at least two of the at least two radiation beams.

It is apparent from the above description that, if one radiation beam breaks down, the intensity of some of the read-out spots will diminish, but the information can still be read out thanks to the contributions from other radiation beams. In a preferred embodiment, the loss of one radiation beam can be compensated for by the remaining sub-radiation beams in that the power of these sub-radiation beams is increased.

For example, consider read-out spot C. If radiation beam R₂ fails, then the read-out spot C will still have contributions from sub-radiation beam S₀₄, sub-radiation beam S₁₃, sub- radiation beam S₃₁, and sub-radiation beam S₄₀. Hence, the breakdown of radiation beam R₂will reduce the intensity of the read-out spot C, but the information can still be read out. Preferably, the failure of radiation beam R₂ is compensated for by an increase in the power supplied to the remaining radiation beams (R₀, R₁, R₃, and R₄). The intensity is thus hardly affected. The method of construction of read-out spots is illustrated with an example for five tracks with reference to FIG. 4, but in general it applies to any number of tracks and any number of read-out spots.

The construction of read-out spots is achieved by means of a grating element 10 as shown in FIG. 4, which can be switched on during read-out and switched off in a write mode. In the write mode, the state of the grating is such that the radiation beams are unchanged, whereas in the read mode the state of the grating is such that it generates sub-beams from different radiation beams which overlap at the read-out spots.

FIG. 5A and FIG. 5B show an embodiment of an optical disc reading device according to the invention. Elements that have the same function or construction as in FIG. 2A and FIG. 2B are designated by the same reference numerals and are not described in any more detail here. The reading device of the present invention comprises a radiation source that simultaneously illuminate tracks 2a, 2b, 2c, 2d, and 2e of an optical disc 1. The information recorded in tracks is illuminated by the radiation beams and read from reflected portions of the radiation beams. According to the present invention, furthermore, the radiation beams can be generated by different radiation sources 4. In the example discussed with respect to FIG. 4, five radiation beams R₀, R₁, R₂, R₃, R₄ are used. These radiation beams can be generated by different radiation sources 4. Each of the radiation sources 4 can have its own current drive which can be modulated independently of other sources, depending on the desired output power of the radiation beam to be emitted by that source. In the reading device of the present invention, even if one radiation beam fails, no information is lost and the information is still read out without recurring operations for additional revolutions of the optical disc and without any track jump being performed, as is required in a prior art reading device of FIG. 2A. To achieve this, the reading device comprises a grating element 10 for transforming each radiation beam into five sub-radiation beams, the spot separation being equal to the distance between every two mutually adjacent tracks 2a, 2b, 2c, 2d, 2e. The grating element 10 for transforming each radiation beam into sub- radiation beams is preferably a periodic structure. The grating element 10 may be made, for example, by embossing a periodic surface variation into a suitable material. The phase of the radiation beam is spatially modulated by differences in surface height. The grating is preferably a binary phase grating in which the difference in height corresponds to the phase difference. In order to switch the grating, the height is effectively switched on/off. Switching is applied to achieve a change from a write mode to a read mode and vice versa. The radiation beams are unchanged in the write mode, whereas in the read mode sub-beams of different radiation beams overlap.

FIG. 5B shows the read-out spots (A, B, C, D, E) formed on five tracks 2a, 2b, 2c, 2d, and 2e according to the invention. Each read-out spot is built up from multiple radiation beams. As explained above with reference to FIG. 4, five read-out spots are formed, each spot illuminating one of the five tracks 2a, 2b, 2c, 2d, and 2e. Each of the five read-out spots consists of contributions from at least three radiation beams. Also, the failure of one radiation source is compensated for by an increase in the power supplied to the remaining radiation sources.

The construction of the grating element suitable for the reading device according to the invention is shown in FIG. 6. In this embodiment, the grating element 11 is made from a birefringent material, so that different linear polarization directions of the radiation beam give the grating different refractive indices. The switching can be achieved by means of a half-wave plate or a Liquid Crystalline Cell(LC) 11a. This element is used to rotate the incoming polarization direction of the radiation beam. The orientation of the fast axis determines the incoming polarization state for a half-wave plate. For the LC cell, a voltage across the LC element determines the orientation of the LC molecules and hence the birefringence of this cell. This determines the incoming polarization state.

The depth of the binary birefringent grating is such that the phase depth for one polarization is a multiple of 2 pi and for the other polarization it is the desired phase depth,

n_{—}=2 pi lambda m and n_e=(alpha+1) 2 pi lambda, where n_o is refractive index along ordinary axis, n_e is refractive index along extraordinary axis, alpha 2 pi gives the desired phase depth of the grating modulo 2 pi, m and 1 are integers, lambda is the wavelength.

An alternative construction of the grating element is shown in FIG. 7. The grating element 12 is made of a Liquid Crystalline (LC) cell comprising a uniaxial liquid crystal material. Applying a voltage change to the electrodes 12A induces a spatially varying refractive index change in the LC cell for one linear polarization direction of the radiation beam. The grating structure is placed in an LC material. The LC cell does not impose a spatially varying refractive index structure at one voltage value (write mode), and the spatial modulation of the refractive index results in the desired binary grating that produces the radiation sub beams at the other voltage value (read mode).

Yet another construction of the grating element is shown in FIG. 8, comprising two grating elements 13, 14 in different positions of a substrate 15. Of the two grating elements 13, 14, one may be a simple glass plate without spatial height variations. The grating elements 13, 14 are moveable with respect to the radiation beams. In one position of the substrate, the radiation beams pass through one of the grating elements (write mode) and in the other position the radiation beams pass through the other grating element (read mode).

A reading device of the present invention according to any one of the previous embodiments is advantageously incorporated in a drive system for reading record carriers such as CD, DVD, Blu-Ray, TwoDOS or near-field disc players where plural tracks are to be reproduced simultaneously without any loss of information as discussed in the present invention.

An optical disc 1 is held at its central area on a disc table in a disc player which incorporates a reading device as shown in FIG. 5A and is rotated about its own axis by a spindle motor coupled to the disc table. In the disc player, the reading device is positioned so as to orient the focusing lens 8 towards the signal-recording surface of the optical disc 1, which is rotated. The reading device is supported so as to be radially movable across the optical disc 1. When the optical disc 1 is rotated about its own axis, the reading device reads the recorded information signal along the recording tracks 2.

The invention has been described with reference to specific embodiments thereof in the present application. It will be evident, however, that various modifications and changes may be made thereto without departing from the broader spirit and scope of the invention as set forth in the appended claims. The Figures and drawings are accordingly to be regarded as illustrative rather than restrictive.

1. A reading device for retrieving information from a record carrier (1), comprising illuminating means for simultaneously illuminating tracks (2) of the record carrier by means of at least two radiation beams, the information recorded in the illuminated tracks being retrieved from reflected portions of the radiation beams, characterized in that the illuminating means are adapted for illuminating each read-out spot consisting of contributions from at least two of the at least two radiation beams.

2. A reading device as claimed in claim 1, wherein the illuminating means comprise a grating element (10) for transforming the at least two radiation beams each into at least two sub-radiation beams, and wherein the illuminating means are adapted for forming the at least one read-out spot by combining sub-radiation beams from at least two of the at least two radiation beams.

3. A reading device as claimed in claim 1, wherein N read-out spots are constructed on N tracks (2), each of the N read-out spots consisting of contributions of at least two radiation beams.

4. A reading device as claimed in claim 2, wherein the grating element (11) is such that the grating comprises a birefringent material, and the grating has different refractive indices for different polarizations of the radiation beam.

5. A reading device as claimed in claim 2, wherein the grating element (12) comprises an LC cell.

6. A reading device as claimed in claim 2, wherein the grating element comprises two grating elements (13,14) in different positions, and a movement is used to move the grating elements (13,14) with respect to the radiation beams.

7. A reading device as claimed in claim 1, wherein each of the radiation beams is generated by a different radiation source (4).

8. A reading device as claimed in claim 1, wherein a failure of one radiation source is compensated for by an increase in the power supplied to the remaining radiation sources.

9. A drive system comprising a reading device as claimed in claim 1 for retrieving information from a record carrier (1).
